(19) United States
(12) Patent Application Publication
(10) Pub. No.: US 2014/0193720 A1
(43) Pub. Date: Jul. 10, 2014

(54) AIR BATTERY

(71) Applicant: Fuminori Mizuno, Susono-shi (JP)

(72) Inventor: Fuminori Mizuno, Susono-shi (JP)

(73) Assignee: TOYOTA JIDOSHA KABUSHIKI KAISHA, Toyota-shi, Aichi (JP)

(21) Appl. No.: 14/125,704

(22) PCT Filed: Jun. 15, 2011
(86) PCT No.: PCT/JP2011/063702

§ 371 Date: Mar. 6, 2014

(51) Int. Cl. H01M 4/96; H01M 12/08

(52) U.S. Cl. CPC H01M 4/96; H01M 12/08; Y10S 977/742; Y10S 977/948; B82Y 30/00
USPC 429/405; 977/742; 977/948

(57) ABSTRACT

The preset invention is to provide an air battery including, in an air electrode layer, a needle-shaped carbon material having more reaction starting points of oxygen reduction reaction than conventional carbon materials. Disclosed is an air battery including at least an air electrode, a negative electrode and an electrolyte layer disposed between the air electrode and the negative electrode, wherein the air electrode is provided with at least an air electrode layer, and the air electrode layer contains a needle-shaped carbon material having an average aspect ratio of 10 or more and a DIG ratio of 0.1 or more.

### TECHNICAL FIELD

The present invention relates to an air battery comprising, in an air electrode layer, a needle-shaped carbon material having more reaction starting points of oxygen reduction reaction than conventional carbon materials.

### BACKGROUND ART

Air batteries are rechargeable batteries that use an elemental metal or metal compound for the negative electrode active material and oxygen for the positive electrode active material. Since oxygen used for the positive electrode active material is obtained from the air, it is not necessary to seal the positive electrode active material in the battery. Accordingly, air batteries are theoretically able to realize greater capacity than secondary batteries using a solid positive electrode active material.

In a lithium-air battery, which is one type of air battery, the reaction of the following Formula (I) proceeds at the negative electrode during discharge:

2Li→2Li⁺+2e⁻ (I)

Electrons generated in Formula (I) perform work in an external load via an external circuit, after which they reach the air electrode. Then, lithium ions (Li⁺) generated in Formula (I) migrate within an electrolyte retained between the negative electrode and the air electrode from the negative electrode side to the air electrode side by electroosmosis.

In addition, the reactions of the following Formulae (II) and (III) proceed at the air electrode during discharge:

2Li⁺+O₂+2e⁻−Li₂O₂ (II)

2Li⁺+1/2O₂+2e⁻Li₂O (III)

The generated lithium peroxide (Li₂O₂) and lithium oxide (LiO₂) accumulate on the air electrode in a solid state.

During charging, the reverse reaction of Formula (I) proceeds at the negative electrode, while the reverse reactions of Formulae (II) and (III) proceed at the air electrode, thereby causing metal lithium to be regenerated at the negative electrode and enabling redischarging.

Conventionally, spherical carbon material such as Ketjenblack, etc. has been used as an electrically conductive material in the air electrode. However, in the case of using the spherical carbon material, there has been a problem that the initial capacity is high but the capacity significantly decreases after repeated charging and discharging. As a technique to solve such a problem, Patent Literature 1 discloses techniques related to a metal air secondary battery comprising an air electrode having an air electrode layer including an electrically conductive material, an negative electrode and a nonaqueous electrolyte, wherein the electrically conductive material is needle-shaped carbon of an average aspect ratio of 10 or more.

### CITATION LIST

### Patent Literature

[Patent Literature 1] Japanese Patent Application Laid-Open (JP-A) No. 2010-287390

### SUMMARY OF INVENTION

### Technical Problem

As a result of diligent researches on the metal air secondary battery disclosed in Patent Literature 1, the inventor of the present invention has found out that the discharge capacity obtainable per one time of discharge has been significantly low.

The present invention has been achieved in light of this circumstance. An object of the present invention is to provide an air battery comprising a needle-shaped carbon material in an air electrode layer having more reaction starting points of oxygen reduction reaction than conventional carbon materials.

### Solution to Problem

An air battery of the present invention comprises at least an air electrode, a negative electrode and an electrolyte layer disposed between the air electrode and the negative electrode, wherein the air electrode is provided with at least an air electrode layer, and the air electrode layer contains a needle-shaped carbon material having an average aspect ratio of 10 or more and a DIG ratio of 0.1 or more.

In the present invention, it is preferable that an average lattice spacing of (002) plane of the needle-shaped carbon material is 0.335 nm or more and less than 0.370 nm.

In the present invention, the needle-shaped carbon material may have a BET specific surface area of 10 to 3,000 m²/g.

In the present invention, the needle-shaped carbon material may be a cup-stacked carbon nanotube.

### Advantageous Effects of Invention

Since the air electrode layer of the present invention contains the needle-shaped carbon material having a D/G ratio of 0.1 or more, that is, a carbon material in a shape of needle having more reaction starting points of the oxygen reduction reaction than conventional carbon materials, giving and receiving electrons between the needle-shaped carbon material and more oxygen molecules are capable. As a result, the present invention can realize greater capacity and higher energy density than conventional air batteries.

### BRIEF DESCRIPTION OF DRAWINGS

FIG. 1 is a schematic perspective view of cup-stacked carbon nanotube.

FIG. 2 is a drawing schematically showing a cross-sectional view sectioned in the direction of lamination of the layer configuration of an example of an air battery according to the present invention.

FIG. 3 is a schematic perspective view of conventional carbon nanotube.

### DESCRIPTION OF EMBODIMENTS

The air battery of the present invention is an air battery comprising at least an air electrode, a negative electrode and an electrolyte layer disposed between the air electrode and the negative electrode, wherein the air electrode is provided with at least an air electrode layer, and the air electrode layer contains a needle-shaped carbon material having an average aspect ratio of 10 or more and a D/G ratio of 0.1 or more.

As aforementioned, since the air battery using spherical carbon particles such as Ketjenblack, etc. in the air electrode layer has high initial capacity but significantly deteriorates after repeated charging and discharging, it has not been possible to use such an air battery repeatedly. On the other hand, as a result of researches of the inventor of the present invention, it has been found out that the air battery using a needle-shaped carbon material such as VGCF, etc. for the air electrode layer as mentioned in Patent Literature 1 has been bearable against repeated use, however, the discharge capacity obtainable per one time of discharge has been significantly low.

It can be considered that the reason for significantly low discharge capacity per one time of discharge in the case of using the needle-shaped carbon material such as VGCF, etc. is that the number of reaction starting points, the distance between reaction starting points, and the area of reaction field in the needle-shaped carbon material are significantly smaller than conventional carbon materials such as ₜhe spherical carbon particle, etc. The reaction referred herein is mainly an oxygen reduction reaction shown in Formulae (II) and/or (III).

As an index of the number of reaction starting point, a D/G ratio can be exemplified. The D/G ratio is a ratio of the peak intensity at 1,360 cm⁻¹ (D band) with respect to the peak intensity at 1,580 cm⁻¹ (G band) in Raman spectrum of a needle-shaped carbon material. The D band is a peak corresponding to a defect site which is likely to be a reaction starting point, for example, a carbon edge and strain in the needle-shaped carbon material, while the G band is a peak corresponding to a graphite moiety which is less likely to be a reaction starting point, for example, a carbon net plane in the needle-shaped carbon material. Therefore, it is considered that if the value of D/G ratio increases, the number of reaction starting point increases.

It is considered that the defect site corresponding to the D band is a place where an oxygen molecule first receives an electron from a needle-shaped carbon material. It is considered that an oxygen radical produced as a result of an oxygen molecule receiving an electron reacts with a metal ion permeated an electrolyte layer, etc., and metal oxides precipitate at the defect site corresponding to the D band and the graphite moiety corresponding to the G band.

As an index of distance between reaction starting points, an average lattice spacing of (002) plane (d₀₀₂) of needle-shaped carbon material obtainable by an X-ray diffraction method or a powder X-ray diffraction method can be exemplified. It is considered that generally, the lower the d₀₀₂ value is, the shorter the distance between carbon edges being reaction starting points becomes.

As an index of area of reaction filed, a BET specific surface area obtainable by a N₂ adsorption method can be exemplified. The BET specific surface area is considered that the BET specific surface area is larger, the higher the discharge capacity becomes, although it does not necessary be an electrochemically effective surface area. The BET specific surface area corresponds to the sum of the area of the aforementioned defect site corresponding to the D band and the area of the aforementioned graphite moiety corresponding to the G band.

The inventor of the present invention has found out that by using a needle-shaped carbon material having an average aspect ratio of a certain value or more and an D/G ratio of a certain value or more for the air electrode layer, the needle-shaped carbon material having more reaction starting points of oxygen reduction reaction than conventional carbon materials is contained in the air electrode layer, thus, giving and receiving electrons between the needle-shaped carbon material and more oxygen molecules are capable, and as a result, both capacity and energy density of the air battery using the air electrode layer can be improved than those of conventional air batteries, and completed the present invention.

The average aspect ratio of needle-shaped carbon material used for the present invention is 10 or more. It is considered that if the average aspect ratio of needle-shaped carbon material is less than 10, the average aspect ratio is too low, thus, when the needle-shaped carbon material is subjected to crushing and mixing, etc. upon producing the air electrode, the needle-shaped carbon material is pulverized to become a carbon material having a structure similar to a spherical carbon material. If the carbon material after pulverization is used for the air electrode, similarly as when the spherical carbon material is used for the air electrode, both electron conductivity and mechanical strength of carbon material decrease, and cycle characteristics of air battery may remarkably deteriorate.

The average aspect ratio of needle-shaped carbon material used for the present invention is preferably from 20 to 100, more preferably from 30 to 70.

In the present invention, examples of method for measuring the average aspect ratio of needle-shaped carbon material include a method of measuring a long diameter and a short diameter in Transmission Electron Microscope (hereinafter it maybe referred as TEM) image and calculating an aspect ratio from the long diameter and the short diameter.

The D/G ratio of needle-shaped carbon material used for the present invention is 0.1 or more. If the D/G ratio of needle-shaped carbon material is less than 0.1, as aforementioned, there is too little reaction starting point to be involved in the oxygen reduction. Hence, when the needle-shaped carbon material is used for an air electrode of an air battery, the discharge capacity of air battery may become low.

The D/G ratio of needle-shaped carbon material used for the present invention is preferably from 0.6 to 1.0, more preferably from 0.8 to 1.0.

In the present invention, examples of method for measuring the DIG ratio of needle-shaped carbon material include, as aforementioned, a method of calculating a D/G ratio from peak intensities of G band and D band in Raman spectrum of a needle-shaped carbon material.

The average lattice spacing of (002) plane, that is d₀₀₂, of the needle-shaped carbon material used for the present invention is preferably 0.335 nm or more and less than 0.370 nm. A needle-shaped carbon material having dₒₙ of less than 0.335 nm does not exist in theory. If d₀₀₂ of needle-shaped carbon material is 0.370 nm or more, the crystallinity of needle-shaped carbon material is too low, thus, giving and receiving electrons between the needle-shaped carbon material and the oxygen molecule may not be sufficiently conducted.

The d₀₀₂ of needle-shaped carbon material used for the present invention is more preferably from 0.335 to 0.360 nm, even more preferably from 0.335 to 0.350 nm.

In the present invention, examples of method for measuring the d₀₀₂ of needle-shaped carbon material include a method of calculating d₀₀₂ from a half bandwidth of diffraction peak of (002) plane in an XRD spectrum of a needle-shaped carbon material.

The BET specific surface area of needle-shaped carbon material used for the present invention is better if it is larger, and may be, for example, from 10 to 3,000 m²/g. If the BET specific surface area is too small, the reaction area to be involved in the oxygen reduction may be too small. Hence, when the needle-shaped carbon material is used for an air electrode of an air battery, the discharge capacity of air battery may be too low.

The BET specific surface area of needle-shaped carbon material used for the present invention is preferably from 10 to 1,600 m²/g.

In the present invention, examples of method for measuring the BET specific surface area of the needle-shaped carbon material include a method of calculating a BET specific surface area by a BET method from a N₂ adsorption measurement of the needle-shaped carbon material under a temperature condition of 77K.

As a typical example of a needle-shaped carbon material satisfying all conditions of the above average aspect ratio, D/G ratio, d₀₀₂ and BET specific surface area, a cup-stacked carbon nanotube can be exemplified.

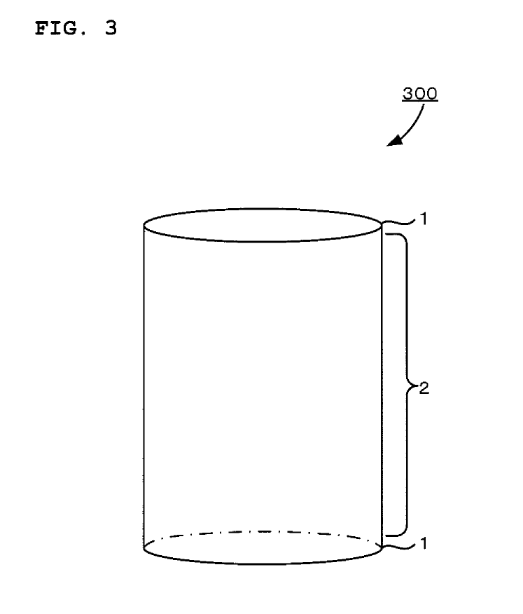

FIG. 3 is a schematic perspective view of a conventional carbon nanotube. To simplify the explanation, FIG. 3 shows a single-layer carbon nanotube, and a depiction of the carbon atom and the carbon-carbon bond is omitted here.

The carbon nanotube 300 is in a form of cylinder mainly made of sp² carbon atoms. The diameters of carbon nanotubes 300 are approximately equal through the whole cylinder. The carbon nanotube 300 is constituted mainly with carbon edges 1, which are the edges of the cylinder, and a carbon net plane 2, which is the body of the cylinder. Accordingly, it is considered that a conventional carbon nanotube has a small area of carbon edge I corresponding to the aforementioned D band, and a large area of carbon steel plane 2 corresponding to the aforementioned G band, thus, the value of D/G ratio is low, and the number of reaction starting point involved in the oxygen reduction is low.

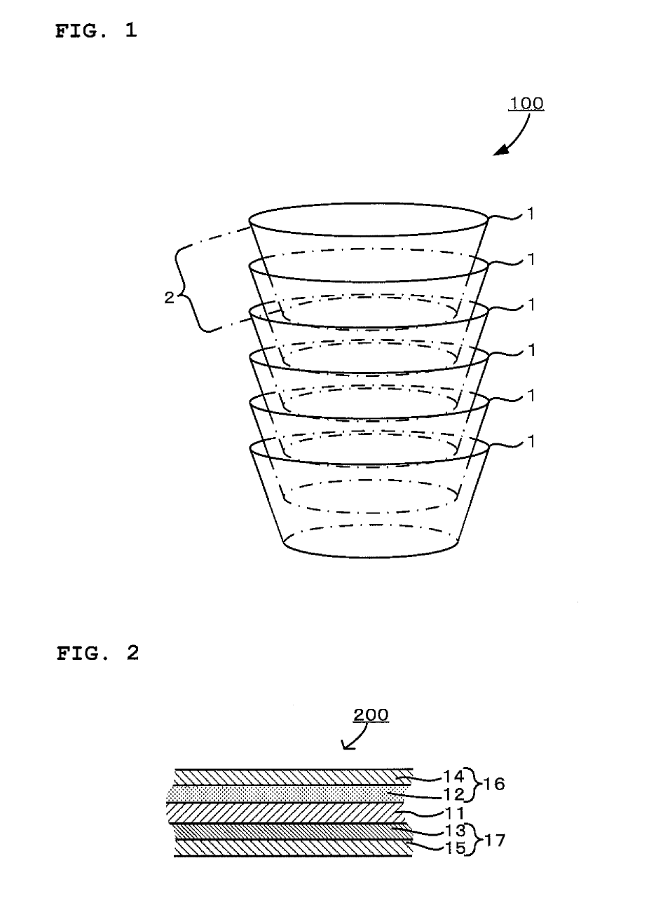

FIG. 1 is a schematic perspective view of cup-stacked carbon nanotube. To simplify the explanation, a depiction of the carbon atom and the carbon-carbon bond is omitted here. FIG. 1 is a schematic view not necessarily reflecting parameters of aspect ratio, average lattice spacing of (002) plane (d₀₀₂), etc. of needle-shaped carbon material used in the present invention.

The cup-stacked carbon nanotube 100 is a so-called assembly of nanotubes, in which two or more cup-formed nanotubes are stacked. Herein, the cup-formed nanotube is in a form of cylinder mainly made of sp² carbon atoms, wherein, as shown in FIG. 1, the diameters in both ends of the cylinder are different and the diameters of the whole cylinder from one end to the other end continuously increase or decrease. In the cup-stacked carbon nanotube 100 as it can be understood from FIG. 1, carbon edges 1 being reaction starting points are regularly arranged and appear on the surface of the assembly. Since the cup-stacked carbon nanotube 100 has a structure that a plurality of cup-formed nanotubes are stacked each other, a part or approximately whole of carbon net plane 2 of one cup-formed nanotube hides inside the carbon steel plane 2 of the other cup-formed nanotube. Therefore, it is considered that since the cup-stacked carbon nanotube 100 has larger area of carbon edge 1 corresponding to the aforementioned D band and smaller area of carbon steel plane 2 corresponding to the aforementioned G band compared with conventional carbon nanotubes, the value of D/G ratio is higher and the number of reaction starting point to be involved in the oxygen reduction is higher. Therefore, by using the cup-stacked carbon nanotube for the air electrode layer, giving and receiving electrons between the cup-stacked carbon nanotube and more oxygen molecules are capable, and as a result, higher capacity and higher energy density than conventional air batteries can be realized.

As another example of a needle-shaped carbon material satisfying all conditions of the above average aspect ratio, D/G ratio, d₀₀₂, and BET specific surface area, there may be a carbon material which is an acid-treated carbon nanofiber, etc. The needle-shaped carbon material satisfying all conditions of the above may have or may not have a tube structure.

The needle-shaped carbon material used for the present invention may be an unsintered or sintered product. The temperature of sintering the needle-shaped carbon material is preferably 3,000° C. or less, more preferably 1,500° C. or less.

FIG. 2 is a drawing schematically showing a cross-sectional view sectioned in the direction of lamination of the layer configuration of one example of the air battery according to the present invention. The air battery of the present invention is not necessarily limited to this example.

The air battery 200 comprises an air electrode 16 provided with an air electrode layer 12 and an air electrode current collector 14, a negative electrode 17 provided with a negative electrode active material layer 13 and a negative electrode current collector 15, and an electrolyte layer 11 sandwiched between the air electrode 16 and the negative electrode 17.

Hereinafter, the air electrode, the negative electrode and the electrolyte layer constituting the air battery of the present invention, and a separator and a battery case suitably used for the air battery of the present invention will be explained in detail.

### (Air Electrode)

The air electrode of the air battery of the present invention is provided with an air electrode layer, and is normally further provided with an air electrode current collector and an air electrode lead connected to the air electrode current collector.

### (Air Electrode Layer)

The air electrode layer in the air battery of the present invention at least contains the aforementioned needle-shaped carbon material. In addition, it may also contain a catalyst, a binder, etc., if necessary.

The content ratio of needle-shaped carbon material in the air electrode layer is preferably from 10 to 99 mass %, more preferably from 20 to 95 mass %, with respect to 100 mass % of the total mass of the air electrode layer. If the content of needle-shaped carbon material is too low, the reaction field decreases and thus the battery capacity may decrease. On the other hand, if the content of needle-shaped carbon material is too high, the content of catalyst hereinafter described may relatively decrease, and a sufficient catalyst function may not be exhibited.

As an example of catalyst used for the air electrode layer, there may be an oxygen active catalyst. Examples of the oxygen active catalyst include members of the platinum group such as nickel, palladium and platinum; perovskite oxides containing a transition metal such as cobalt, manganese or iron; inorganic compounds containing a noble metal oxide such as ruthenium, iridium or palladium; metal-coordinated organic compounds having a porphyrin backbone or phthalocyanine backbone; and manganese oxides.

From the viewpoint of smoother electrode reaction, a catalyst may be supported on the aforementioned needle-shaped carbon material.

The air electrode layer at least contains the needle-shaped carbon material. It is preferable that a binder that immobilizes the needle-shaped carbon material is further contained. Examples of the binder include polyvinylidene fluoride (PVdE), polytetrafluoroethylene (PTFE) and rubber-type resins such as styrene-butadiene rubber (SBR), etc. Although there are no particular limitations thereon, the content ratio of the binder in the air electrode layer is preferably 30 mass % or less, more preferably from 1 to 10 mass %, with respect to 100 mass % of the total mass of the air electrode layer.

Examples of method for producing the air electrode layer include, but may not be limited to hereto: a method of mixing the raw material of the air electrode layer including the needle-shaped carbon material and so on and rolling (extending by applying pressure) the mixture; and a method of mixing the above raw material into a solvent to prepare a slurry, and applying the slurry on an air electrode current collector hereinafter described. Examples of method of applying the slurry to the air electrode current collector include publicly known methods such as a spraying method, a screen printing method, a doctor blade method, a gravure printing method, and a die-coating method.

The thickness of the air electrode layer depends on use of the air battery, and may be, for example, from 2 to 500 μm, preferably from 5 to 300 μm.

### (Air Electrode Current Collector)

The air electrode current collector in the air battery of the present invention carries out current collection of the air electrode layer. There is no particular limitation on the material of the air electrode current collector if it has electrical conductivity. Examples of the material include stainless steel, nickel, aluminum, iron, titanium and carbon. Examples of the form of the air electrode current collector include foil, plate and mesh (grid) forms. In the present invention in particular, a mesh-like air electrode current collector is preferable from the viewpoint of having superior current collection efficiency. In this case, a mesh-like air electrode current collector is normally arranged on or inside the air electrode layer. Moreover, the air battery of the present invention may also have another air electrode current collector (such as a foil-like current collector) that collects charge accumulated by the mesh-like air electrode current collector. In addition, in the present invention, a battery case hereinafter described may also be provided with the function of an air electrode current collector.

The thickness of the air electrode current collector is, for example, preferably within the range of 10 to 1,000 μm, and more preferably within the range of 20 to 400 μm.

### (Negative Electrode)

The negative electrode in the air battery of the present invention is preferably provided with a negative electrode layer containing a negative electrode active material, and is normally further provided with a negative electrode current collector and a negative electrode lead connected to the negative electrode current collector.

### (Negative Electrode Layer)

The negative electrode layer in the air battery of the present invention contains the negative electrode active material containing a metal material, an alloy material, and/or a carbon material. Specific examples of metal and alloy materials that can be used in the negative electrode active material include alkaline metals such as lithium, sodium and potassium, group 2 elements such as magnesium and calcium, group 13 elements such as aluminum, transition metals such as zinc and iron, and alloy materials and compounds containing these metals.

Examples of alloys containing lithium element include lithium-aluminum alloys, lithium-tin alloys, lithium-lead alloys and lithium-silicon alloys. Examples of metal oxides containing lithium element include lithium titanium oxide, etc. Examples of metal nitrides containing lithium element include lithium cobalt nitrides, lithium iron nitrides and lithium manganese nitrides. In addition, lithium coated with a solid electrolyte can also be used in the negative electrode layer.

The negative electrode layer may contain only the negative electrode active material, or may contain at least one of an electrically conductive material and a binder besides the negative electrode active material. For example, in the case the negative electrode active material is in the form of a foil, a negative electrode layer may only contain the negative electrode active material. On the other hand, in the case the negative electrode active material is in the form of a powder, a negative electrode layer may contain the negative electrode active material and the binder. An explanation of the binder is omitted here since it is the same as one previously described in “Air electrode layer”.

There is no particular limitation on the electrically conductive material used in the negative electrode layer if it has electrical conductivity. Examples thereof include carbon materials, perovskite electrically conductive materials, porous electrically conductive polymers and metal porous bodies. The carbon materials may or may not have a porous structure. Specific examples of carbon materials having a porous structure include mesoporous carbon, etc. On the other hand, specific examples of carbon materials not having a porous structure include graphite, acetylene black, carbon nanotubes and carbon fibers.

### (Negative Electrode Current Collector)

There is no particular limitation on the material of the negative electrode current collector in the air battery of the present invention if it has electrical conductivity. Examples of the material include copper, stainless steel, nickel and carbon. Among the above, SUS or Ni is preferably used as the negative electrode current collector. Examples of the form of the negative electrode current collector include foil, plate and mesh (grid) forms. In the present invention, the battery case to be hereinafter described may also be provided with the function of the negative electrode current collector.

### (Electrolyte Layer)

The electrolyte layer in the air battery of the present invention is interposed between the air electrode layer and the negative electrode layer, and has the function of exchanging metal ions between the air electrode layer and the negative electrode layer.

In the electrolyte layer, an electrolyte solution, a gel electrolyte, a solid electrolyte, etc. can be used. They may be used alone or in a combination of two or more kinds.

An aqueous electrolyte solution or a non-aqueous electrolyte solution can be used as the electrolyte solution.

It is preferable that the type of the non-aqueous electrolyte solution is appropriately selected according to the type of metal ion which migrates the electrolyte. For example, a non-aqueous electrolyte solution containing a lithium salt and a non-aqueous solvent is normally used for a lithium air battery. Examples of the lithium salt include inorganic lithium salts such as LiPF₆, LiBF₄, LiClO₄ and LiAsF₆, and organic lithium salts such as LiCF₃SO₃, LiN(SO₂CF₃)₂, (Li-TFSI), LiN(SO₂C₂F₅)₂ and LiC (SO₂CF₃)₃. Examples of non-aqueous solvents include ethylene carbonate (EC), propylene carbonate (PC), dimethyl carbonate (DMC), diethyl carbonate (DEC), ethyl methyl carbonate (EMC), ethyl carbonate, butylene carbonate, y-butyrolactone, sulfolane, acetonitrile (AcN), dimethoxymethane, 1,2-dimethoxyethane (DME), 1,3-dimethoxypropane, diethyl ether, tetraethylene glycol dimethyl ether (TEGDME), tetrahydrofuran, 2-methyltetrahydrofuran, dimethyl sulfoxide (DMSO) and mixtures thereof. The concentration of the lithium salt in the non-aqueous electrolyte solution may be within the range of, for example, 0.5 to 3 mol/L.

In the present invention, representative examples of non-aqueous electrolyte solution or non-aqueous solvents to be used include low volatile liquids such as ionic liquids such as N-methyl-N-propylpiperidinium-bis(trifluoromethanesulfonyl)imide (P13TFSI), N-methyl-N-propylpyrrolidinium-bis(trifluoromethanesulfonyl)imide (P13TFSI), N-butyl-N-methylpyrrolidinium-bis(trifluoromethanesulfonyl)imide (P14TFSI), N,N-diethyl-N-methyl-N-(2-methoxyethyl)ammonium-bis(trifluoromethanesulfonyl)imide (DEMETFSI), N,N,N-trimethyl-N-propylammonium-bis(trifluoromethanesulfonyl)imide (TMPATFSI).

Among the above non-aqueous solvents, it is preferable to use the electrolyte solution solvents stable to oxygen radical in order to proceed the oxygen reduction reaction represented by Formula (II) or (III). Examples of such a non-aqueous solvent include acetonitrile (AcN), 1,2-dimethoxyethane (DME), dimethyl sulfoxide (DMSO), N-methyl-N-propylpiperidinium-bis(trifluoromethanesulfonyl)imide (PP13TFSI), N-methyl-N-propylpyrrolidinium-bis(trifluoromethanesulfonyl)imide (P13TFSI), and N-butyl-N-methylpyrrolidinium-bis(trifluoromethanesulfonyl)imide (P14TFSI).

It is preferable that the type of the aqueous electrolyte solution is appropriately selected according to the type of metal ion which migrates the electrolyte. For example, an aqueous electrolyte solution containing a lithium salt and water is normally used for a lithium air battery. Examples of the lithium salt include lithium salts such as LiOH, LiCl, LiNO₃ and CH₃CO₂Li.

The gel electrolyte used in the present invention is normally obtained by adding a polymer to a non-aqueous electrolyte solution and gelling. The non-aqueous gel electrolyte for a lithium air battery can be obtained, for example, by adding a polymer such as polyethylene oxide (PEO), polyacrylonitrile (PAN) or polymethylmethacrylate (PMMA) to the non-aqueous electrolyte solution described above and gelling. In the present invention, an LiTFSI(LiN(CF₃SO₂)₂)-PEO-based non-aqueous gel electrolyte is preferable.

As the solid electrolyte, any of solid sulfide electrolytes, solid oxide catalysts and polymer electrolytes can be used.

Specific examples of the solid sulfide electrolyte include Li₂S—P₂S₅, Li₂S—P₂S₃, Li₂S—P₂S₃—P₂S₅, Li₂S—SiS₂, Li₂S—Si₂S, Li₂S—B₂S₃, Li₂S—GeS₂, LiI—Li₂S—P₂S₅, LiI—Li₂S—SiS₂—P₂S₅, Li₂S—SiS₂—Li₄SiO₄, Li₂S—SiS₂—Li₃PO₄, Li₃PS₄—Li₄GeS₄, Li_{3.4}P_{0.6}Si_{0.4}S₄, Li_{3.25}P_{0.25}Ge_{0.76}S₄ and Li₄₋ₓGe₁₋ₓPₓS₄.

Specific examples of the solid oxide electrolyte include LiPON (lithium phosphorous oxynitride), Li_{1.3}Al_{0.3}Ti_{0.7} (PO₄)₃, La_{0.51}Li_{0.34}TiO_{0.74}, Li₃PO₄, Li₂SiO₂ and Li₂SiO₄.

It is preferable that the polymer electrolyte is appropriately selected according to the type of metal ion which migrates the electrolyte. For example, a polymer electrolyte for a lithium air battery normally contains a lithium salt and a polymer. As the lithium salt, the aforementioned inorganic lithium salts and/or organic lithium salts may be used. The polymer is not particularly limited if it forms a complex with the lithium salt, for example, polyethylene oxides, etc.

### (Separator)

A separator can be provided between the air electrode and the negative electrode of the battery of the present invention. Examples of the separator include porous films made of polyethylene or polypropylene, and non-woven fabrics such as resin non-woven fabrics (e. g. polypropylene non-woven fabric) or glass fiber non-woven fabrics.

These materials usable for the separator may be impregnated with the electrolyte solution and used for a support material of electrolyte solution.

### (Battery Case)

The air battery of the present invention normally has a battery case that houses the air electrode, negative electrode, electrolyte and the like. Specific examples of the shape of the battery case include a coin shape, flat shape, cylindrical shape and laminated shape. The battery case may be a battery case that is open to the atmosphere or a sealed battery case. The battery case that is open to the atmosphere is a battery case having a structure that at least allows the air electrode layer to adequately contact the atmosphere. On the other hand, in the case the battery case is the sealed battery case, a gas (air) introduction tube and a venting tube are preferably provided in the sealed battery case. In this case, the gas that is introduced and vented preferably has a high oxygen concentration, and is more preferably dry air or pure oxygen. In addition, the oxygen concentration is preferably increased during discharge and decreased during charging.

An oxygen permeable membrane or water repellent film may be provided in the battery case according to the structure of the battery case.

### EXAMPLES

Hereinafter, with reference to Examples and Comparative example, the present invention will be explained in more detail, but the present invention may not be limited thereby.

1. Production of Air electrode

### Production Example 1

Firstly, a cup-stacked carbon nanotube (manufactured by GSI Creos Corporation; hereinafter it may be referred to as CS-CNT) unsintered product and a PTFE binder (manufactured by Daikin Industries, Co. Ltd.) were mixed at a ratio of CS-CNT:PTFE=90 mass %:10 mass %. Next, the mixture was rolled by roll press, dried, and appropriately cut to produce an air electrode layer. Then, a SUS mesh (manufactured by The Nilaco Corporation; SUS304, 100 mesh) as an air electrode current collector was applied on one side of the air electrode layer. Thus, an air electrode of Production example 1 was obtained.

### Production Example 2

Firstly, CS-CNT (manufactured by GSI Creos Corporation) was sintered under a temperature condition of 2,800° C. Next, CS-CNT after the sintering and a PTFE binder (manufactured by Daikin Industries, Co. Ltd.) were mixed at a ratio of CS-CNT:PTFE=90 mass %:10 mass %. Then, similarly as Production example 1, the mixture was rolled, dried, etc. to produce an air electrode layer. Then, a SUS mesh (manufactured by The Nilaco Corporation; SUS304, 100 mesh) as an air electrode current collector was applied on one side of the air electrode layer. Thus, an air electrode of Production example 2 was obtained.

### Production example 3

Firstly, vapor-phase growth carbon fiber (manufactured by Showa Denko K.K.; hereinafter referred to as VGCF), and a PTFE binder (manufactured by Daikin Industries, Co. Ltd.) were mixed at a ratio of VGCF:PTFE=90 mass %:10 mass %. Next, the mixture was rolled by roll press, dried, and appropriately cut to produce an air electrode layer. Then, a SUS mesh (manufactured by The Nilaco Corporation; SUS304, 100 mesh) as an air electrode current collector was applied on one side of the air electrode layer. Thus, an air electrode of Production example 3 was obtained.

### 2. Evaluation of Carbon Material

The average aspect ratio, average lattice spacing of (002) plane (d₀₀₂), D/G ratio and BET specific surface area of the CS-CNT unsintered product used for Production example 1, the CS-CNT sintered product used for Production example 2, and the VGCF used for Production example 3 were measured.

### 2-1. Measurement of Average Aspect Ratio

The long diameter and short diameter of one carbon material particle in a TEM image of each of the above carbon materials were measured. A value calculated from dividing the long diameter by the short diameter was referred to as an aspect ratio of the carbon material particle. Such calculation of aspect ratio by TEM observation was performed for approximately 300 carbon material particles of the same kind, and the average of aspect ratios of these carbon material particles was referred to as an average aspect ratio of the carbon material.

The specific conditions of TEM observation are as follows:
transmission electron microscope (product name: Tecnai; manufactured by FEI); and
accelerating voltage: 300 kV.
   2-2. Measurement of Average Lattice Spacing of (002) Plane (d₀₀₂)

An XRD pattern of each of the above carbon materials was measured by a powder X-ray diffraction method, and an average lattice spacing of (002) plane (d₀₀₂) was calculated from the half bandwidth position of the peak of (002) plane. The specific conditions and analysis method of the powder X-ray diffraction measurement are as follows:
beam source: CuKα;
tube voltage: 40 kV;
tube current: 40 mA; and
analysis method: FT method.

### 2-3. Measurement of D/G Ratio

Each of the above carbon materials was subjected to Raman measuring by means of a laser Raman spectrophotometer using a laser light source of 488 nm. From Raman spectrum of each carbon material obtained, the peak intensities of 1,360 cm⁻¹ (D band) and 1,580 cm⁻¹ (G band) having subtracted the baseline were calculated, and the peak intensity of the D band with respect to the peak intensity of the G band was calculated.

Raman measuring was performed at any three points in each of carbon materials and the peak intensity ratios were calculated for each. The average of peak intensity ratios of three points was referred to as a D/G ratio of the carbon material.

### 2-4. Measurement of BET Specific Surface Area

Each of the above carbon materials was subjected to a N₂ adsorption measurement under a temperature condition of 77K, and the BET specific surface area was calculated by a BET method.

Table 1 shown below shows the comparison of the average aspect ratios, average lattice spacing of (002) plane (d₀₀₂), D/G ratios, and BET specific surface areas of the CS-CNT unsintered product used in Production example 1, the CS-CNT sintered product used in Production example 2 and the VGCF used in Production example 3.

TABLE 1

| | | | | | BET |
|---|---|---|---|---|---|
| | | | | | specific |
| | | | | | surface |
| | | Average | d₀₀₂ | D/G | area |
| | Carbon material | aspect ratio | (nm) | ratio | (m²/g) |
| Production | CS-CNT | 50 | 0.340 | 0.833 | 47 |
| example 1 | (unsintered product) | | | | |
| Production | CS-CNT | 50 | 0.338 | 0.136 | 46 |
| example 2 | (sintered product) | | | | |
| Production | VGCF | 50 | 0.337 | 0.065 | 12 |
| example 3 | | | | | |

### 3. Production of Air Battery

### Example 1

The air electrode of Production example 1 was used as an air electrode.

An electrolyte solution was prepared by dissolving lithium bis(trifluoromethanesulfonyl)imide (manufactured by Kishida Chemical Co., Ltd.) in N-methyl-N-propylpiperidinium-bis (trifluoromethanesulfonyl) imide (manufactured by Kant Chemical Co., Inc.; PP13TFSI) to have a concentration of 0.32 mol/kg, and agitating the mixture under an argon atmosphere for one night. Nonwoven fabric made of polypropylene was prepared as a separator.

A SUS foil (manufactured by The Nilaco Corporation; SUS304) was prepared as a negative electrode current collector. Metal lithium (manufactured by Honjo Metal Co., Ltd.) was applied on one side of the SUS foil. Thus, a negative electrode was produced.

As a battery case, a case having oxygen intake holes on the air electrode side was prepared.

The members were housed in the battery case so that, from the bottom of the battery case, a negative electrode current collector, metal lithium, an electrolyte solution-impregnated separator, a CS-CNT unsintered product-containing air electrode layer, and an air electrode current collector were stacked in this order. Thus, an air battery of Example 1 was produced.

All of the aforementioned processes were performed in a glove box under a nitrogen atmosphere.

### Example 2

Except that the air electrode of Production example 2 was used instead of the air electrode of Production example 1, an air battery of Example 2 was produced similarly as Example 1 using the same members of Example 1.

### Comparative Example 1

Except that the air electrode of Production example 3 was used instead of the air electrode of Production example 1, an air battery of Comparative example 1 was produced similarly as Example 1 using the same members of Example 1.

### 4. Measurement of Discharge Capacity of Air Battery

The discharge capacity of each of air batteries in Examples 1 and 2, and Comparative example 1 was measured.

Firstly, each air battery was left under a temperature condition of 60° C. for 3 hours. Then, a constant current discharge measurement was performed by means of a charging and discharging test device (product name: BTS2004H; manufactured by Nagano Co., Ltd.) while supplying pure oxygen (99.9%; manufactured by Taiyo Nippon Sanso Corporation) to the air electrode layer of each air battery under conditions of a temperature of 60° C. and a current density of 0.02 mA/cm². A value calculated from dividing the obtained discharge capacity by the mass of each air electrode was referred to as a discharge capacity of the air battery.

Table 2 shown below shows the comparison of the discharge capacities of air batteries in Examples 1 and 2, and Comparative example 1.

TABLE 2

| | | | Discharge |
|---|---|---|---|
| | | | capacity |
| | Air electrode | Carbon material | (mAh/g) |
| Example 1 | Production example 1 | CS-CNT | 193 |
| | | (unsintered | |
| | | product) | |
| Example 2 | Production example 2 | CS-CNT | 122 |
| | | (sintered product) | |
| Comparative | Production example 3 | VGCF | 43 |
| example 1 | | | |

### 5. Summary of Evaluation

As shown in Table 1, the air battery of Comparative example 1 contains VGCF having an average aspect ratio of 50, d₀₀₂ of 0.337 nm, a D/G ratio of 0.065 and a BET specific surface area of 12 m²/g in the air electrode layer. As shown in Table 2, the discharge capacity of air battery in Comparative example 1 is 43 mAh/g. Accordingly, it can be understood that, the discharge capacity of air battery in Comparative example 1 using the needle-shaped carbon material having an average aspect ratio of 10 or more but having a D/G ratio of less than 0.1 is less than 40% of the discharge capacity of air batteries in Examples 1 and 2 hereinafter described.

On the other hand, as shown in Table 1, the air battery of Example 1 contains CS-CNT having an average aspect ratio of 50, d₀₀₂ of 0.340 nm, a D/G ratio of 0.833 and a BET specific surface area of 47 m²/g in the air electrode layer, while the air battery of Example 2 contains CS-CNT having an average aspect ratio of 50, d₀₀₂, of 0.338 nm, a D/G ratio of 0.136 and a BET specific surface area of 46 m²/g in the air electrode layer. As shown in Table 2, the discharge capacity of air battery in Example 1 is 193 mAh/g, while the discharge capacity of air battery in Example 2 is 122 mAh/g. Accordingly, it can be understood that the air batteries of Examples 1 and 2 using the needle-shaped carbon material having an average aspect ratio of 10 or more and a D/G ratio of 0.1 or more have higher discharge capacity than the air battery using the conventional carbon material.

### REFERENCE SIGNS LIST

1: Carbon edge
2: Carbon net plane
11: Electrolyte layer
12: Air electrode layer
13: Negative electrode active material layer
14: Air electrode current collector
15: Negative electrode current collector
16: Air electrode
17: Negative electrode
100: Cup-stacked carbon nanotube
200: Air battery
300: Conventional carbon nanotube

1. An air battery comprising at least an air electrode, a negative electrode and an electrolyte layer disposed between the air electrode and the negative electrode,
wherein the air electrode is provided with at least an air electrode layer, and
the air electrode layer contains a needle-shaped carbon material having an average aspect ratio of 10 or more and a D/G ratio of 0.1 or more.

2. The air battery according to claim 1, wherein an average lattice spacing of (002) plane of the needle-shaped carbon material is 0.335 nm or more and less than 0.370 nm.

3. The air battery according to claim 1, wherein the needle-shaped carbon material has a BET specific surface area of 10 to 3,000 m²/g.

4. The air battery according to claim 1, wherein the needle-shaped carbon material is a cup-stacked carbon nanotube.
